(19) United States
(12) Patent Application Publication
(10) Pub. No.: US 2016/0348809 A1
(43) Pub. Date: Dec. 1, 2016

(54) PIPE FLOAT ASSEMBLY WITH ROLL AXIS STABILITY

(71) Applicant: Neptune Flotation, LLC, Indianapolis, IN (US)

(72) Inventors: Andrew W. Elder, Zionsville, IN (US); Alex B. Berezhnev, Indianapolis, IN (US); David J. Jordan, Carmel, IN (US)

(21) Appl. No.: 15/164,320

(22) Filed: May 25, 2016

Related U.S. Application Data
(60) Provisional application No. 62/166,535, filed on May 26, 2015.

(51) Int. Cl. F16L 1/24

(52) U.S. Cl. CPC F16L 1/24

(57) ABSTRACT

A float assembly securable to an elongate conveyance wherein the elongate conveyance defines a longitudinal axis and the float assembly has a roll axis parallel with the longitudinal axis. The float assembly includes a first buoyant float member coupled with the float assembly. The float assembly also has a configuration wherein buoyancy and gravitational forces acting on the float assembly resist rotation of the float assembly about the roll axis when the float assembly is secured to the elongate conveyance and disposed in a body of water. In some embodiments, the float assembly includes a body defining a buoyant pipe support that includes a central float section and two outer float sections disposed laterally outwardly from the central float section. In some embodiments, ballast is used to provide roll axis stability. In yet other embodiments, the float assembly includes a keel member to enhance roll axis stability.

### CROSS REFERENCE TO RELATED APPLICATIONS

This application claims priority under 35 U.S.C. 119(e) of U.S. provisional patent application Ser. No. 62/166,535 filed on May 26, 2015 entitled PIPE FLOAT ASSEMBLY WITH ROLL AXIS STABILITY the disclosure of which is hereby incorporated herein by reference.

### BACKGROUND

The present invention relates to floatation devices for elongate conveyances such as pipes, hoses and cables.

In some situations, hoses and pipes are used to transport liquids, slurries and other mixtures across a body of water. It is often desirable to have the transporting hose or pipe float on the surface of the water or other liquid when performing such transport. Similarly, it is often desirable to route electrical cables or other auxiliary lines across a body of water.

One common application where such floating pipelines are used is in dredging operations. A variety of different floatation devices have been developed for maintaining an elongate conveyance such as a pipe, hose or cable at the surface, above the surface or just below the surface of the water. Floats are commonly attached to the pipeline for this purpose. Conventional floats attached to such pipelines are often able to rotate relative to the pipeline.

U.S. Pat. Pub. 2013/0280973 A1 discloses a float that can be attached to a pipeline wherein the float grips the pipeline to prevent relative rotation of the float and the pipeline. The floats disclosed in U.S. Pat. Pub. 2013/0280973 A1 have a number of advantages, including the ability to maintain the stability of the floats about the roll axis when the pipe remains stationary. When the pipe on which the floats are mounted is subject to rotation, however, floats which securely grip the pipe will be likely to rotate with the pipe. Further improvements in floatation devices remain desirable.

### SUMMARY

The present invention provides a float assembly that maintains a desired orientation about the roll axis of the float assembly. As used herein, the roll axis refers to the longitudinal axis of the float assembly. When the float assembly is secured to an elongate pipe, the centerline of the pipe will be collinear or parallel with the roll axis of the float assembly.

The invention comprises, in one form thereof, a float assembly securable to an elongate conveyance wherein the elongate conveyance defines a longitudinal axis and the float assembly has a roll axis parallel with the longitudinal axis. The float assembly includes a polymeric body defining an enclosed interior volume whereby the body defines a buoyant pipe support. The body includes a central float section and first and second outer float sections disposed on opposite lateral sides of the central float section. A first arm extends laterally from the central float section to the first outer float section and a second arm extends laterally from the central float section to the second outer float section. The elongate conveyance is securable to the float assembly above the central float section.

In some embodiments, of the float assembly, each of the first and second arms includes a plurality of upwardly projecting and laterally extending ribs. In those embodiments having such a plurality of ribs, the plurality of ribs disposed on the first arm may define a plurality of upwardly opening recesses whereby a first longitudinally extending auxiliary line may be positioned in the plurality of upwardly opening recesses. The auxiliary lines may be, for example, an electrical power line, a diesel fuel line, a data communications cable, rope and/or other utilitarian line. Additionally, the plurality of ribs one either or both arms may define a plurality of apertures with each set of apertures defining an axis disposed parallel with the longitudinal axis.

The float assembly may, in some embodiments, include a plurality of removable support pads positioned on the central float section to engage and support the elongate conveyance. For example, steel support pads could be employed when the elongate conveyance is a steel pipe and polymeric support pads could be employed when the elongate conveyance is a polymeric pipe. The central float section of the float assembly may also define an upwardly opening trough on its upper surface for receiving the elongate conveyance wherein the plurality of removable support pads are disposed within the trough and wherein a plurality of attachment interfaces are disposed on the central float section whereby securement straps engaging the elongate conveyance can be secured to the float assembly at the attachment interfaces.

In some embodiments of the float assembly, the outer perimeter of each of the first and second outer float sections defines a plurality of apertures wherein each of the plurality of apertures are adapted to secure a line attaching a bumper to the float assembly.

In some embodiments, the float assembly is configured such that, when the float assembly is positioned on a horizontal planar surface, the central float section and each of the first and second outer float sections all contact the horizontal planar surface with the first and second arms being spaced upwardly from the horizontal planar surface. In such an embodiment, the float assembly may also include a central float section that defines an upwardly opening trough on its upper surface for receiving the elongate conveyance such that a plurality of the float assemblies are vertically stackable when positioned on a horizontal planar surface with a lower portion of the central float section of a first float assembly being positioned in the upwardly opening trough of a second float assembly.

In some embodiments, the float assembly includes an accessory connection interface for securing a rigid elongate shaft to the float assembly wherein the rigid elongate shaft positions an accessory at a vertical distance above the float assembly. For example, the accessory mounted on the rigid elongate shaft might take the form of a light or a flag.

In various embodiments described above, the float assembly may be adapted to support the elongate conveyance above a water surface. In some exemplary embodiments, the float assembly is adapted to support an elongate conveyance having a diameter within the range of 12 inches (30.48 cm) to 20 inches (50.8 cm) and wherein the float assembly provides an uplifting force on the elongate conveyance of at least 6,000 pounds (26,689 Newtons) when the float assembly is positioned in a body of water with the water surface disposed 6 inches (15.24 cm) below a bottom surface of the elongate conveyance.

The invention comprises, in another form thereof, a float assembly securable to an elongate conveyance wherein the elongate conveyance defines a longitudinal axis and the float assembly has a roll axis parallel with the longitudinal axis. The float assembly includes a body defining an enclosed interior volume whereby the body defines a first buoyant float member. The float assembly has a configuration wherein buoyancy and gravitational forces acting on the float assembly resist rotation of the float assembly about the roll axis when the float assembly is secured to the elongate conveyance and disposed in a body of water and wherein the float assembly allows rotation of the elongate conveyance relative to the float assembly when the float assembly is secured to the elongate conveyance.

In some embodiments, the float assembly further includes a stop surface engageable with a collar or flange disposed on the elongate conveyance to thereby limit longitudinal movement of the float assembly on the elongate conveyance. In such an embodiment having a stop surface, the stop surface may be defined by a recess in the first float member wherein the recess is spaced longitudinally inwardly from opposite longitudinal ends of the first float member. Such an embodiment may additionally include a second float member securable to the first buoyant float member to thereby encircle the elongate conveyance wherein the second float member defines a second recess, the second recess and the recess disposed on the first float member defining a toroidal recess for receiving the collar or flange disposed on the elongate conveyance.

In some embodiments, the float assembly further includes ballast coupled with the float assembly to thereby maintain the float assembly in a desired orientation when secured to the elongate member and disposed in a body of water. In some embodiments that include ballast, the ballast may be positioned below and external to the first float member when the float member is secured to the elongate conveyance and disposed in a body of water.

In some embodiments of the float assembly, the assembly further includes a keel member coupled with the float assembly and projecting away from the elongate conveyance and below a water surface when the float assembly is secured to the elongate conveyance and positioned in a body of water.

In some embodiments of the float assembly, the first buoyant float member includes first and second buoyant float members, the first and second buoyant float members being spaced laterally outwardly from the roll axis and disposed on opposite sides of the roll axis when the float assembly is secured to the elongate conveyance and disposed in a body of water. In such an embodiment, the float assembly may further include a third buoyant float member secured to the elongate conveyance wherein the first and second buoyant float members are integrally formed with the third buoyant float member. Such a float assembly may further include a fourth float member wherein the fourth float member is securable to the third buoyant float member whereby the third and fourth float members encircle the elongate conveyance.

In an embodiment wherein the float assembly includes first and second float members spaced laterally outwardly from the roll axis, the float assembly may further include a structural framework formed out of a plurality of elongate rigid members wherein the first and second buoyant float members are secured to the structural framework with the structural framework being securable to the elongate conveyance whereby the first and second buoyant float members are disposed laterally outwardly from the elongate conveyance on opposing sides of the longitudinal axis and thereby resist rotation of the float assembly about the roll axis. In an embodiment having a structural framework, the float assembly may further include a third buoyant float member secured to the structural framework between the first and second float members and disposed under elongate conveyance.

In some embodiments of the float assembly having a structural framework, the first and second buoyant float members include attachment tabs extending outwardly therefrom with the structural framework being secured to at least one of the attachment tabs on each of the first and second buoyant float members. In some embodiments having such attachment tabs, each of the first and second buoyant float members may include a plurality of attachment tabs, the tabs defining at least one slot on each of the first and second buoyant float members, at least one of the plurality of elongate rigid members forming the structural framework being disposed in the at least one slot on each of the first and second buoyant float members.

The invention comprises, in yet another form thereof, a float assembly securable to an elongate conveyance wherein the elongate conveyance defines a longitudinal axis and the float assembly has a roll axis parallel with the longitudinal axis. The float assembly includes a body defining an enclosed interior volume whereby the body defines a first buoyant float member. The float assembly has a configuration wherein buoyancy and gravitational forces acting on the float assembly resist rotation of the float assembly about the roll axis when the float assembly is secured to the elongate conveyance and disposed in a body of water. A second float member defining a second enclosed interior volume is securable to the first buoyant float member whereby the first and second float members encircle the elongate conveyance when secured thereto.

In some embodiments, the float assembly allows relative rotation of the first and second float members and the elongate conveyance when the first and second float members are secured to the elongate conveyance.

In some embodiments, the second float member includes a removable cap for controlling access to an interior volume of the second float member and thereby allowing ballast to be added and removed from the interior volume.

In some embodiments, the float assembly includes ballast that is positioned below and external to the first and second float members when the first and second float members are secured to the elongate conveyance and disposed in a body of water.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is an exploded view of a float assembly and pipe.

FIG. 2 is another exploded view of a float assembly and pipe.

FIG. 3 is yet another exploded view of a float assembly and pipe.

FIG. 4 is a perspective view of a float assembly disposed on a pipe.

FIG. 5 is a partially exploded view of a float assembly with a flag attachment.

FIG. 6 is a detail view of the flag attachment of FIG. 5.

FIG. 7 is a partially exploded of a float assembly with a beacon attachment.

FIG. 8 is a detail view of the beacon attachment of FIG. 7.

FIG. 9 is a perspective view of a float assembly with a secondary conveyance mounted thereon.

FIG. 10 is a detail view of the bracket assembly of FIG. 9.

FIG. 11 is a perspective view of the bracket assembly of FIG. 9.

FIG. 12 is a front view of the bracket assembly of FIG. 9.

FIG. 13 is a perspective view of a float assembly mounted on a pipe.

FIG. 14 is a schematic cross sectional view of a removable cap.

FIG. 15 is a schematic cross sectional view of a float member with ballast.

FIG. 16 is a perspective view of a float assembly with an external ballast assembly.

FIG. 17 is a schematic view of an attachment assembly for the external ballast assembly.

FIG. 18 is a perspective view of a float assembly with a keel member.

FIG. 19 is a perspective view of a float assembly with integral outriggers.

FIG. 20 is a front exploded schematic view of the float assembly of FIG. 19.

FIG. 21 is a float assembly having a structural frame and two outrigger floats.

FIG. 22 is a float assembly with a structural frame, two outrigger floats and a central float.

FIG. 23A is a detail perspective view showing the attachment of a structural frame to a float.

FIG. 23B is a top view of the detail shown in FIG. 23A.

FIG. 24 is perspective view of a float assembly and elongate conveyance.

FIG. 25 is a front view of the float assembly of FIG. 24.

FIG. 26 is a side view of the float assembly of FIG. 24.

FIG. 27 is a front view showing a stack of two float assemblies of FIG. 24.

FIG. 28 is a schematic exploded view showing the attachment of a support pad.

FIG. 29 is a schematic exploded view showing an attachment strap.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

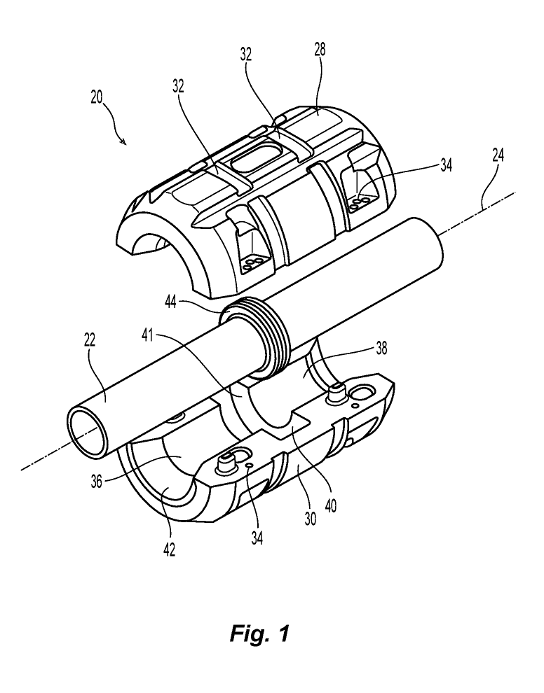

FIG. 1 shows an exploded view of a float assembly 20 and an elongate conveyance 22. Conveyance 22 defines a longitudinal axis 24. In the embodiment illustrated in FIG. 1, longitudinal axis 24 is collinear with roll axis 26 of float assembly 20. Float assembly 20 includes a first buoyant float member 28 and a second float member 30. First and second float members 28, 30 are secured to each other to encircle conveyance 22 and thereby secure the float members 28, 30 to conveyance 22. FIG. 4 illustrates the float members 28, 30 secured together about conveyance 22.

Float members 28, 30 can be readily secured together using straps or threaded fasteners. Securement straps can be seated in recesses 32 which circumscribe float members 28, 30. Alternatively, threaded fasteners can be passed through apertures 34 to secure float members 28, 30. The use of such straps and fasteners is described in greater detail in U.S. Pub. 2013/0280973 A1 which is hereby incorporated herein by reference.

The inward facing surface 36 of both float members 28, 30 include a smooth cylindrical surface portion 38, a recessed portion 40 and flared ends 42. The use of a smooth cylindrical surface 38 allows pipe float members 28, 30 to rotate relative to elongate conveyance 22 when float members 28, 30 are secured to conveyance 22. This relative rotation means that the roll axis of the float assembly will be substantially collinear with the longitudinal axis of the conveyance when the float assembly is secured thereto. As further discussed below, this also means that when float assembly 20 remains in a substantially constant orientation about its roll axis when positioned in a body of water, the conveyance 22 positioned therein can rotate relative to float assembly 20 without causing float assembly 20 to rotate about its roll axis.

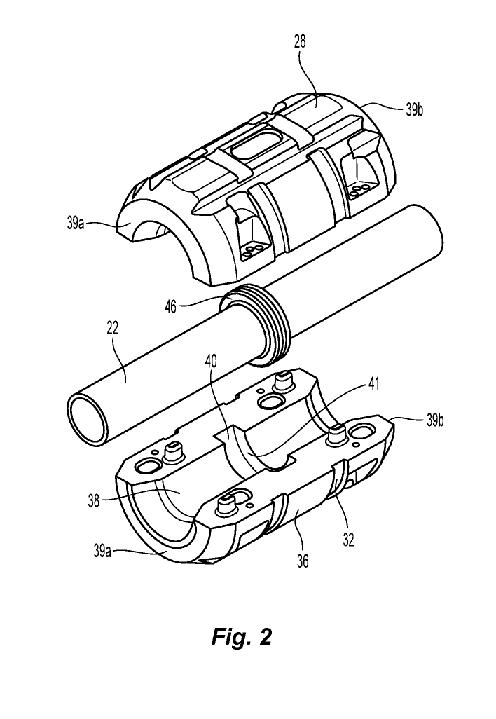

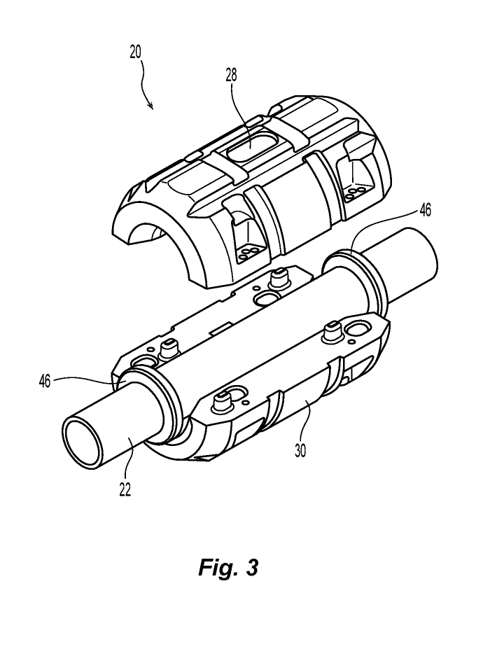

A recess or groove 40 is configured to receive a flange or collar disposed on conveyance 22 and thereby prevent longitudinal shifting of float assembly 20 on conveyance 22. In the illustrated embodiment, each of the float members 28, 30 include a recess 40 that form a toroidal recess for receiving a flange or collar when float members 28, 30 are secured together about a conveyance 22 with recess 40 being spaced longitudinally inwardly from the opposite longitudinal ends 39a, 39b of float members 28, 30. Recess 40 defines laterally extending stop surfaces 41 which will engage pipe flange 44 and prevent further longitudinal movement of pipe float assembly 20 if float assembly 20 begins to shift. In the illustrated embodiment, lateral surfaces 41 extend at a perpendicular angle to longitudinal axis 24. Alternative embodiments, however, could employ similar stop surfaces which extend laterally from axis 24 at a non-perpendicular angle. Oftentimes, conveyances 22 will include flanges 44 at the ends of individual segments of the conveyance for attaching the individual segments together. When the conveyance 22 does not utilize such flanges or the flanges are not located at the desired longitudinal position on conveyance 22, a collar 46 can be secured to conveyance 22. Such collars 46 can be welded or mechanically attached to the conveyance 22 and be received in recess 40 to prevent longitudinally shifting of float assembly 20 as depicted in FIG. 2. For example, the collar may include one or more threaded fasteners that are engageable with conveyance 22 in a manner similar to a set screw. The collar may also be formed out of an individual ring or two semi-circular parts that are secured together, e.g., with fasteners. FIG. 3 shows how two collars 46 can be positioned on opposite longitudinal ends of float assembly 20 to prevent longitudinal movement of the float assembly 20. In the embodiment depicted in FIG. 3, the opposing axial end surfaces of float members 28, 30 each define a laterally extending stop surface for engagement with collars 46. This arrangement can be used with float members that do not include a recess 40.

It will sometimes be desirable to prevent or limit the rotational movement of float assembly 20 about the roll axis 26 of float assembly 20. In other words, provide float assembly 20 with roll axis stability. There are numerous different reasons why such roll axis stability may be desirable. For example, when the float assembly has roll axis stability, an accessory such as a beacon or flag can be secured to the top side of the float assembly and that accessory will be maintained above the elongate conveyance. Without roll axis stability, such accessories could rotate to a lower position where the accessory might not function properly or at all.

When the elongate conveyance will maintain its rotational position about its longitudinal axis, the float assembly can be provided with a structure that tightly grips the conveyance 22 and thereby prevents relative rotational movement of the float assembly about the conveyance to provide roll axis stability. If the conveyance 22 is subject to rotation about its longitudinal axis 24, preventing relative rotational movement between the float assembly and conveyance will cause the float assembly to rotate with the conveyance and thereby prevent roll axis stability. Float assembly 20 is configured such that the buoyancy and gravitational forces acting on the float assembly resist rotation of the float assembly about the roll axis when the float assembly is secured to the conveyance and disposed in a body of water. When used with a conveyance 20 that is subject to rotation about its longitudinal axis, float assembly 20 may be provided with an inner surface that allows for relative rotation of float assembly 20 and conveyance 22 and float assembly 20 can still maintain roll axis stability. Similarly, if such a float assembly 20 is attached to a non-rotating conveyance, it will also maintain roll axis stability.

Generally, it will be desirable for a float assembly 20 to be able to rotate relative to conveyance 22 when the float assembly is configured to resist rotation about the roll axis. However, in some circumstances, it may be useful for such a float assembly to tightly grip the conveyance and prevent relative rotation. For example, if the conveyance is not subject to rotation, having the float assembly both tightly grip the conveyance and be configured to resist rotation about the roll axis will allow the float assembly to maintain roll axis stability even if the grip between float assembly and the conveyance fails. Also, if it is desired to maintain the conveyance in a desired rotational position and the forces acting to rotate the conveyance are not sufficient to overturn the float assemblies attached thereto, it may be desirable to use float assemblies 20 that firmly grip the conveyance to prevent relative rotation and which are also configured to provide roll axis stability.

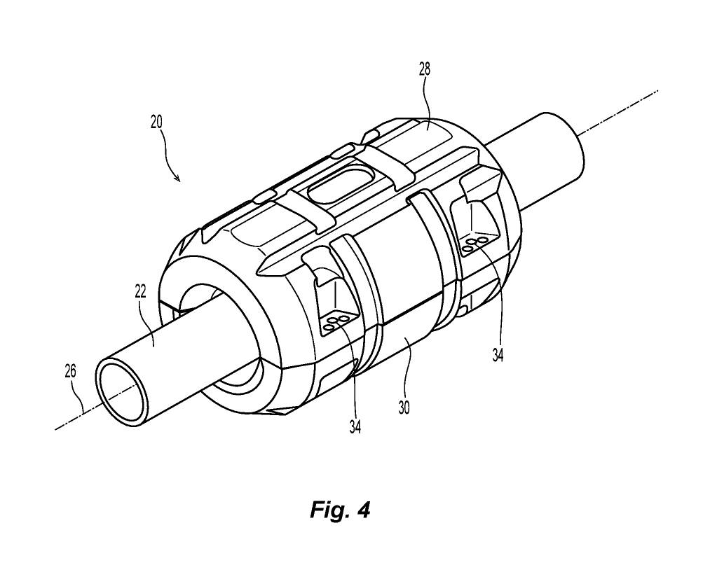

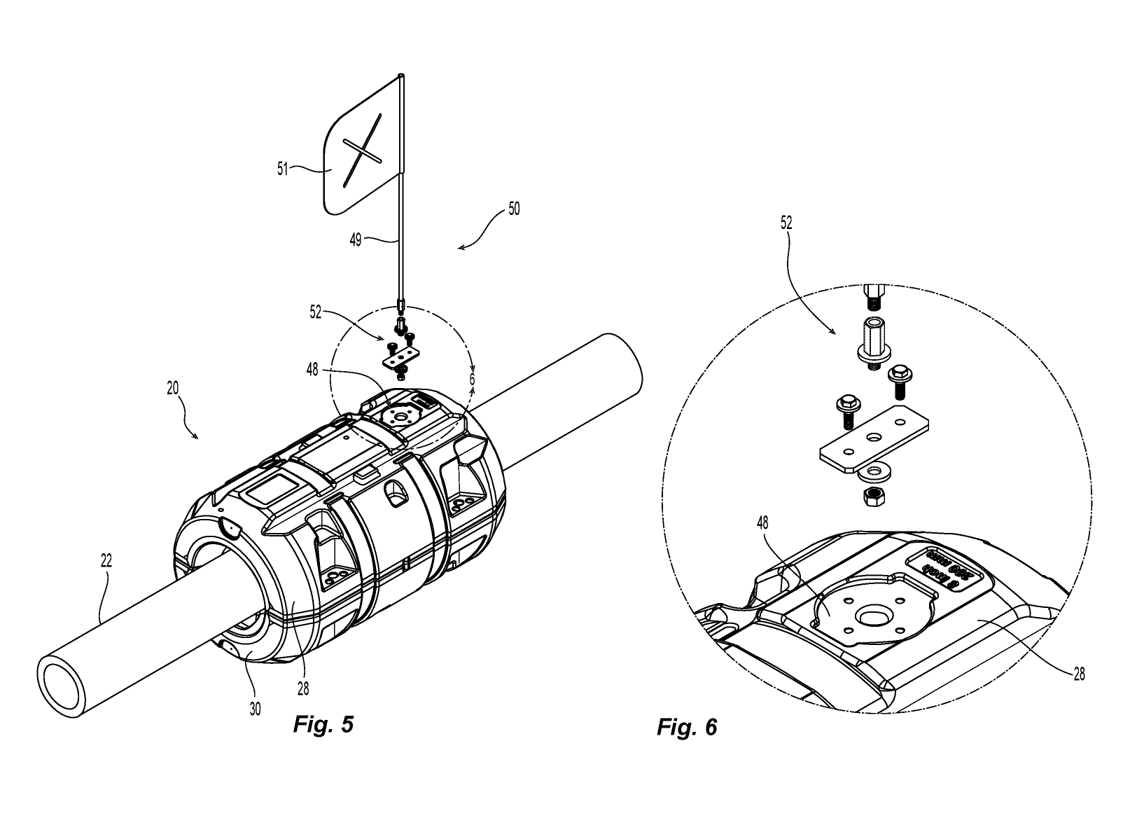

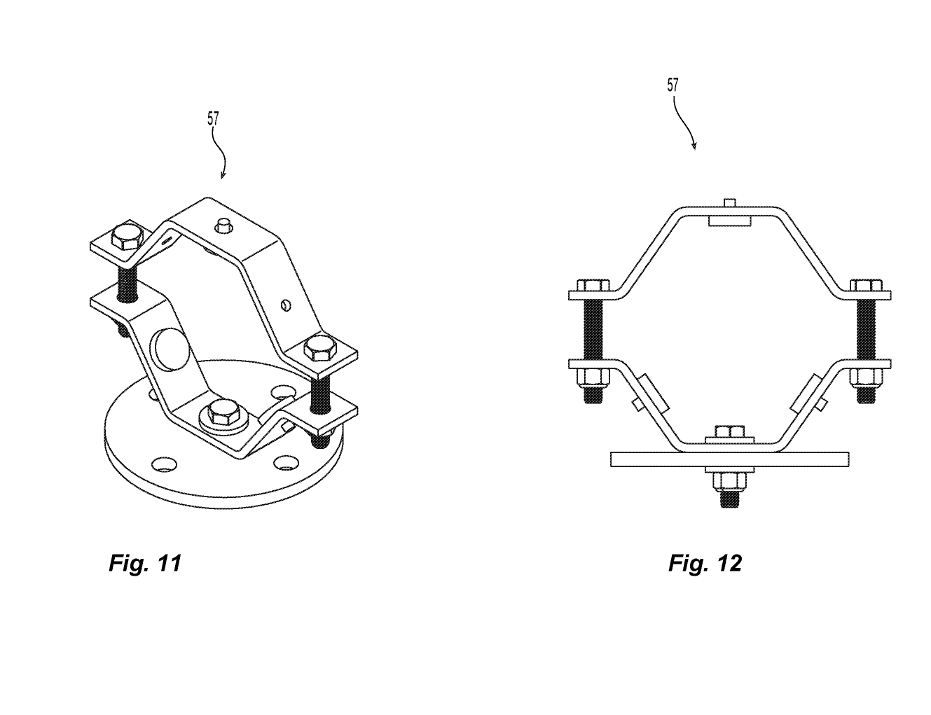

FIGS. 5-12 illustrate examples of accessories that can be beneficially employed with a float assembly 20 having roll axis stability. An accessory connection interface 48 on float member 28 is provided to secure the accessories. FIGS. 5 and 6 illustrate a flag assembly 50 having an attachment bracket 52. Bracket 52 is secured to interface 48. A similar flag assembly 50 and attachment bracket 52 are described in U.S. Pub. 2013/0280973 A1.

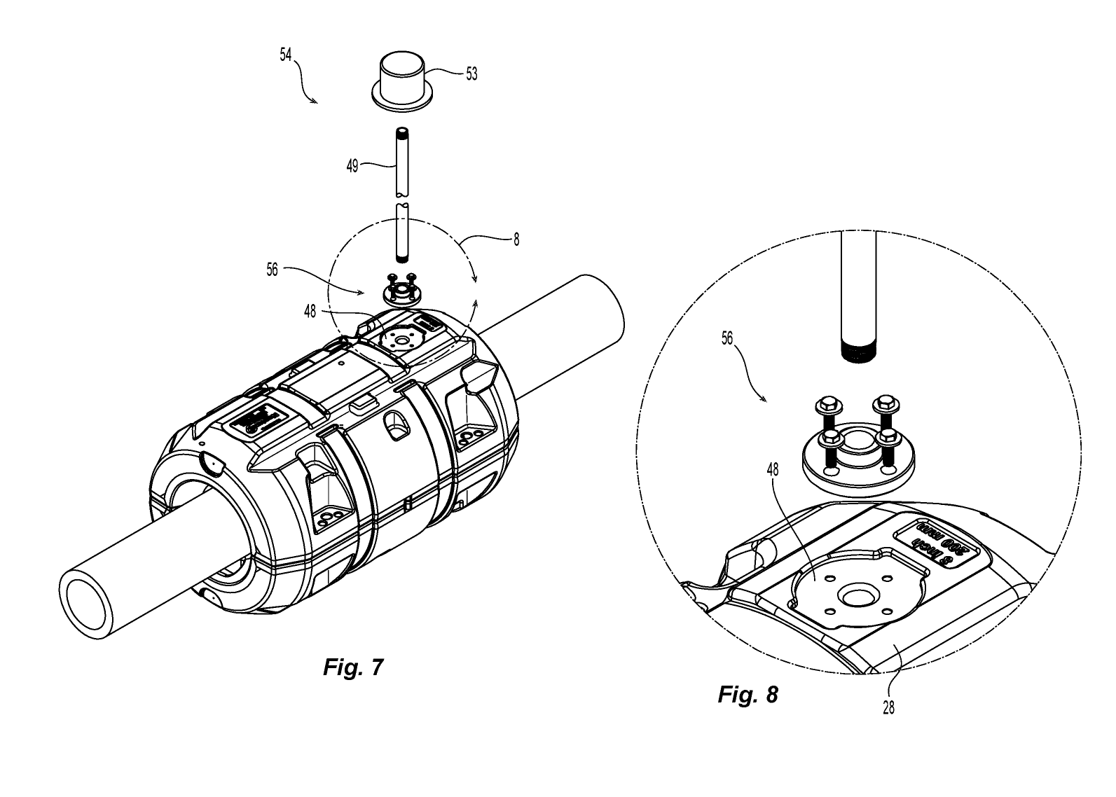

FIGS. 7 and 8 illustrate a beacon 54 and attachment bracket 56. Bracket 56 is secured to interface 48. A similar beacon 54 and attachment bracket 56 are described in U.S. Pub. 2013/0280973 A1.

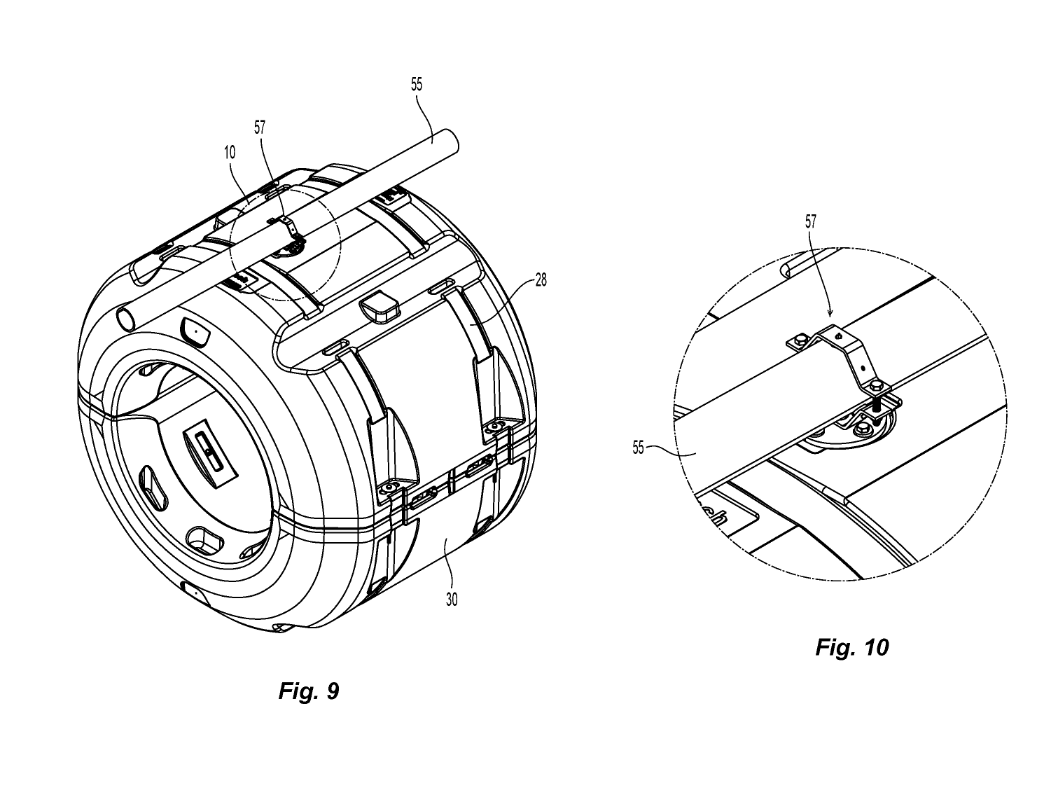

FIGS. 9-12 illustrate an elongate longitudinal member 55 and attachment bracket 57. Bracket 57 is secured to interface 48. A similar elongate longitudinal member 55 and attachment bracket 57 are described in U.S. Pub. 2013/0280973 A1. Elongate longitudinal member 55 is a longitudinally extending auxiliary line such as an electrical power line, a diesel fuel line, a data communications cable, rope and/or other utilitarian longitudinally extending line.

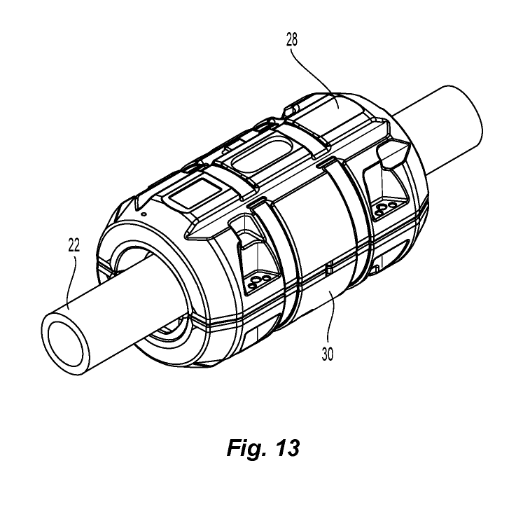

FIGS. 13-22 illustrate several features that can be used individually or in any number of different combinations to provide a float assembly with roll axis stability. FIGS. 13-17 illustrate embodiments wherein ballast is coupled with the float assembly to maintain the float assembly in a desired orientation when it is secured to conveyance 22 and disposed in a body of water.

FIGS. 13-15 illustrate an embodiment wherein ballast 58 is positioned in the lower float member 30. This renders float member 30 heavier than the upper float member 28 and thereby maintains float member 30 at a position below conveyance 22. Many different materials can be used to form ballast 58. For example, sand or gravel could be used to provide a heavier than water ballast 58. Alternatively, water could be employed as the ballast 58. It is also possible to use a ballast that is less dense than water, such as foam, so long as it is sufficiently heavy to render float member 30 heavier than float member 28 and maintain float member 30 in a position below conveyance 22.

As can be seen in FIG. 13 float members 28, 30 are secured together so that float members 28, 30 encircle conveyance 22 with the ballast being disposed in float member 30 which is positioned to encircle the bottom half of conveyance 22. A removable threaded cap 60 is engaged with threaded collar 62 to provide for convenient access to interior volume 64 of float member 30. The illustrated float member 30 is formed by a rotational molded polymeric body 65 that encloses interior volume 64. A seal member 63 is positioned between the polymeric body 65 that forms float member 30 and collar 62. Cap 60 and collar 62 may take the form of a fluid-tight gas cap assembly for a marine fuel tank. The use of threaded cap 60 allows ballast 58 to be readily added and removed from interior volume 64. FIG. 15 is a schematic cross sectional view showing ballast 58 disposed in the interior 64 of float member 30.

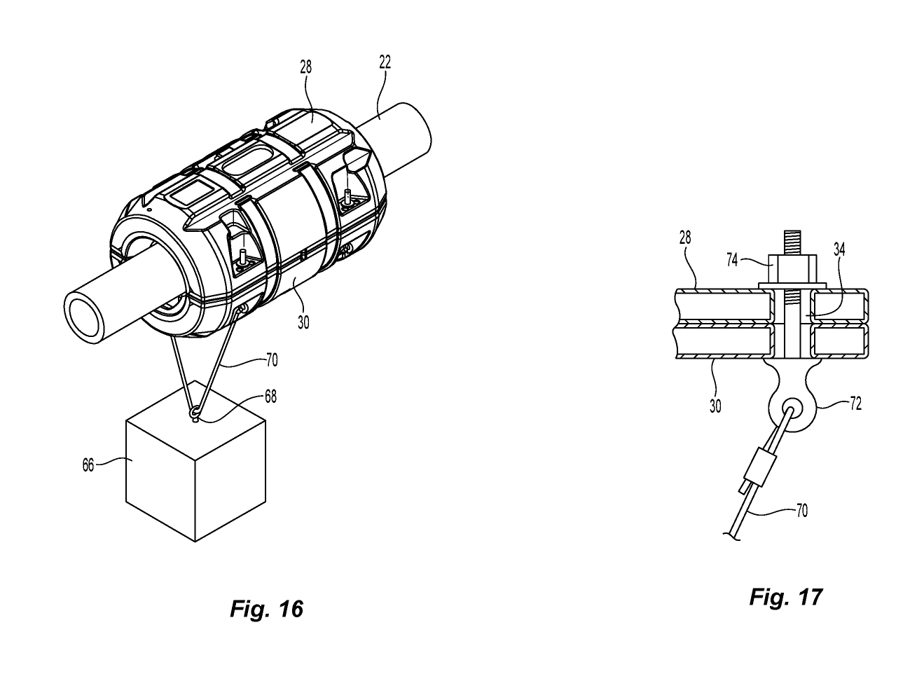

While FIGS. 13-15 illustrate an embodiment employing internal ballast, FIGS. 16 and 17 illustrate an embodiment having external ballast 66. In this embodiment, ballast 66 is positioned below and external to the float members when the float assembly is secured to the conveyance and disposed in a body of water. An external ballast can be coupled to an individual buoyant float member or to a float assembly having two float members 28, 30 secured together about a conveyance 22 as depicted in FIG. 16. The external ballast 66 is denser than water and is secured to at least one fixed location on the float assembly whereby the ballast 66 will control the orientation of float assembly 20 on conveyance 22 and prevent rotation about roll axis 26.

Ballast 66 may be formed out of various denser than water materials such as steel or concrete. It may also take the form of a plastic container or other vessel filled with a dense material such as sand or gravel. In FIG. 16, ballast 66 takes the form of a concrete block with an embedded eyebolt projecting therefrom. A strap or rope 70 is threaded through eyebolt 68 and secures ballast 66 to float assembly 20. In an alternative embodiment, ballast 66 could be formed by one or more concrete blocks such as those conventionally used in building construction. Strap 70 could be threaded through one of the openings in concrete blocks to secure them to the float assembly.

FIG. 17 schematically depicts one method of securing an external ballast 66 to float assembly 20. In this embodiment, an eyebolt 72 is passed through apertures 34 in float members 28, 30 and secured with a nut 74. Eyebolt 72 and nut 74 not only provide an attachment point for the external ballast 66 but also help secure the float members 28, 30 together about conveyance 22. Strap 70 is threaded through eyebolt 72 to attach ballast 66. As best understood with reference to FIG. 16, two eyebolts are attached to the float assembly on opposite lateral sides of conveyance 22 whereby ballast 66 is attached at two fixed locations on float assembly 20 and is positioned directly below conveyance 22.

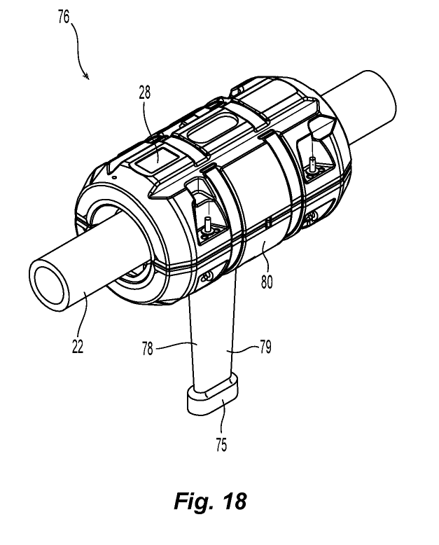

An embodiment 76 employing a keel member 78 is depicted in FIG. 18. In this embodiment, buoyant float member 28 is attached to a bottom float member 80 having a keel member 78 projecting downward therefrom into the body of water. In the illustrated embodiment, keel member 78 is formed integrally with the remainder of float member 80. Float member 80, including keel 78, can be formed out of a polymeric material using a molding process. In the illustrated embodiment, both float member 80 and keel 78 are hollow with the interior volumes being in communication.

Keel member 78 has a relatively large opposite surfaces 79 that define planes which are positioned generally perpendicular to the direction in which such planes 79 would move if float assembly 76 were rotated about roll axis 26. Keel member 78 thereby generates resistance to movement of the keel member through the water when float assembly 76 is subjected to a force tending to impart rotation about roll axis 26. The functionality of keel member 78 is further enhanced by providing ballast within keel member 78. In the illustrated embodiment, float member 80 is provided with a removable cap 60 to introduce ballast 58, such as sand or water, into keel member 78. Alternative embodiments could employ other forms of ballast. For example, if the material being used to form the keel member was sufficiently dense, the keel member could be a solid member to thereby provide it with sufficient ballast to orient the keel member downwardly when the float assembly is mounted on a conveyance 22 and placed in a body of water.

It is further noted that the keel member 78 could be a separate member and be attached to float member 80 with threaded fasteners, straps or other appropriate means. It is also noted that the most distal portion 75 of keel member 78 is enlarged to act as a container for ballast. By positioning the ballast at a greater distance to the roll axis, the moment arm of the ballast is increased and thereby increases the effectiveness of the ballast in providing roll axis stability.

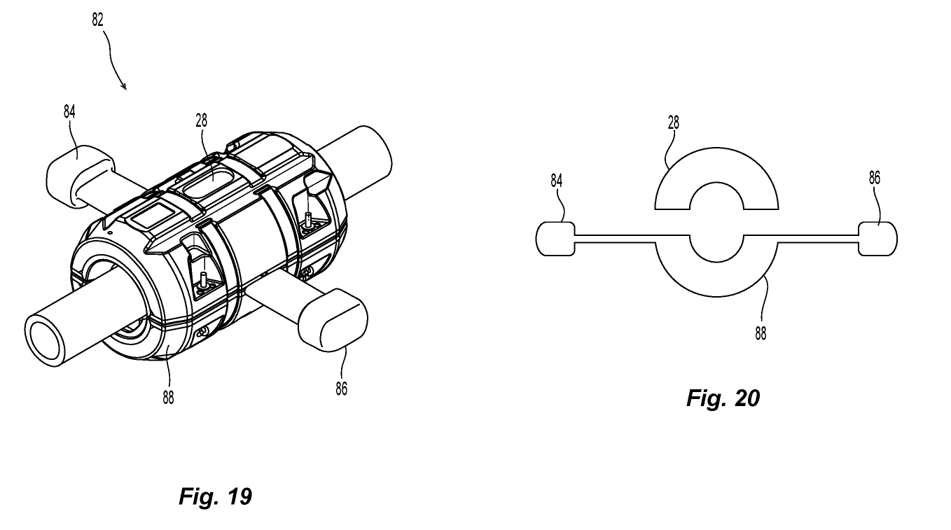

Still other embodiments are illustrated in FIGS. 19-22 which illustrate float assemblies wherein roll axis stability is provided by utilizing an outrigger arrangement. In these embodiments, first and second buoyant float members 84, 86; 94, 96 are spaced laterally outwardly from the roll axis 26 and disposed on opposite sides of the roll axis 26 when the float assembly is secured to the conveyance 22 and disposed in a body of water.

FIGS. 19 and 20 illustrate a float assembly 82 having first and second buoyant float members 84, 86 that are integrally formed with a third buoyant float member 88 that is secured to conveyance 22. Third float member 88 is generally similar to float member 30 except for the first and second buoyant float members 84, 86 that extend laterally outwardly therefrom. Similar to keel member 78, buoyant float members 84, 86 can be integrally molded with float member 88. Float members 84, 86 can either be hollow or filled with a foam material while still retaining the buoyancy of float members 84, 86. A fourth buoyant float member 28 can be secured to float member 88. Float members 28, 88 can be secured together in the same manner as float members 28, 30. When secured together, float members 28, 88 encircle conveyance 22 and thereby secure float assembly 82 to conveyance 22.

FIG. 20 provides a schematic end view of float assembly 82 and more clearly shows how both float members 84, 86 extend from float member 88. Alternatively, each float member 88, 28 could have a single one of the buoyant float members 84, 86 extending therefrom. Then, when the float members were secured to conveyance 22, the float members 84, 86 could be positioned to extend outwardly in opposite directions. By positioning the buoyant float members 84, 86 on opposite sides of roll axis 26 they function as outriggers to provide roll axis stability to float assembly 82.

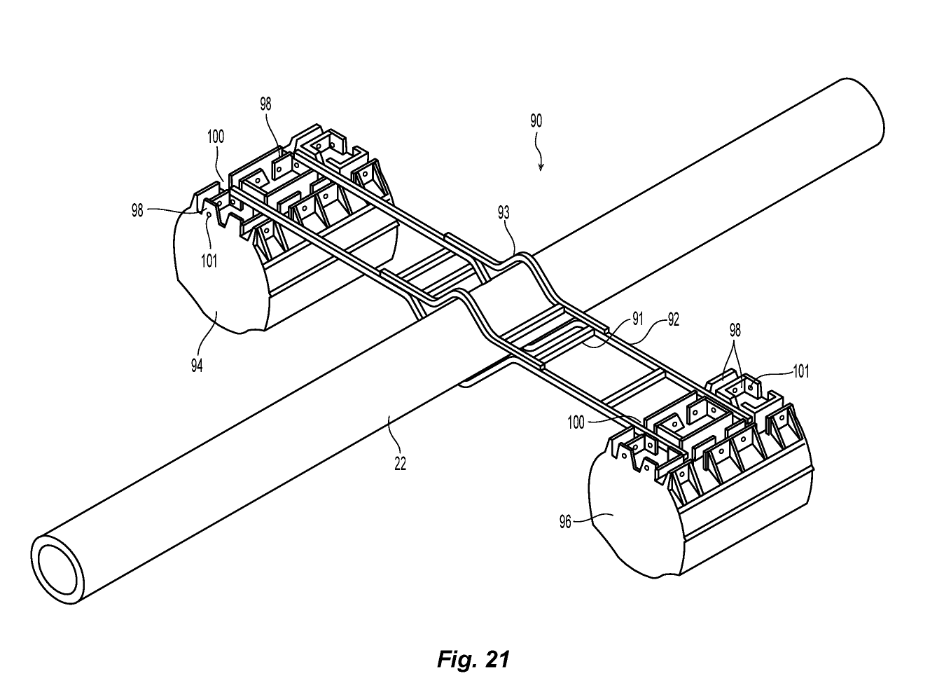

FIG. 21 illustrates a float assembly 90 which includes a structural framework 92 and first and second buoyant float members 94, 96 that are spaced laterally outwardly from the roll axis 26. Structural framework 92 is formed out of a plurality of elongate rigid members 91 in a manner similar to a truss or space-frame. The structural framework 92 has a central portion 93 that encircles the elongate conveyance and thereby secures float assembly 90 to conveyance 22. Central portion 93 also permits relative rotation between framework 92 and conveyance 22. Framework may be formed out of various suitable materials such as steel tubing or polymeric tubing having suitable strength characteristics.

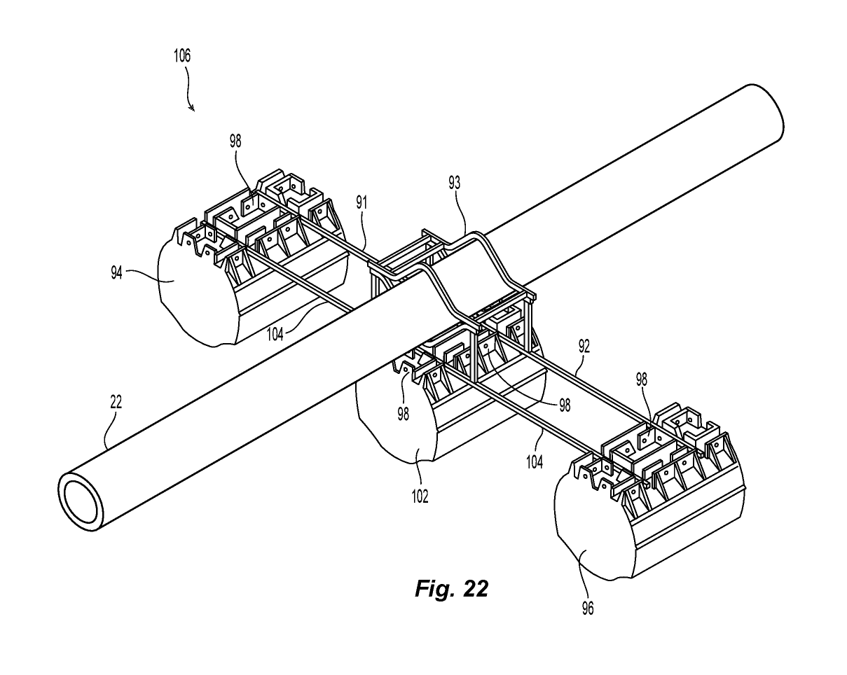

Float members 94, 96 are hollow rotationally molded floats formed out of polymeric material in the illustrated embodiment. Other suitable buoyant members may also be employed. Floats 94, 96 have a series of attachment tabs 98 extending upwardly from their upper surface. Tabs 98 form channels or slots 100 therebetween for receiving framework 92 as can be seen in FIGS. 21 and 22. Tabs 98 may also include apertures 101 for receiving fasteners to secure framework 92 thereto. Tabs 98, channels 100 and/or apertures 101 can also be used to secure to the upper surface of float members 94, 96. It is also possible to secure accessories to the framework 92.

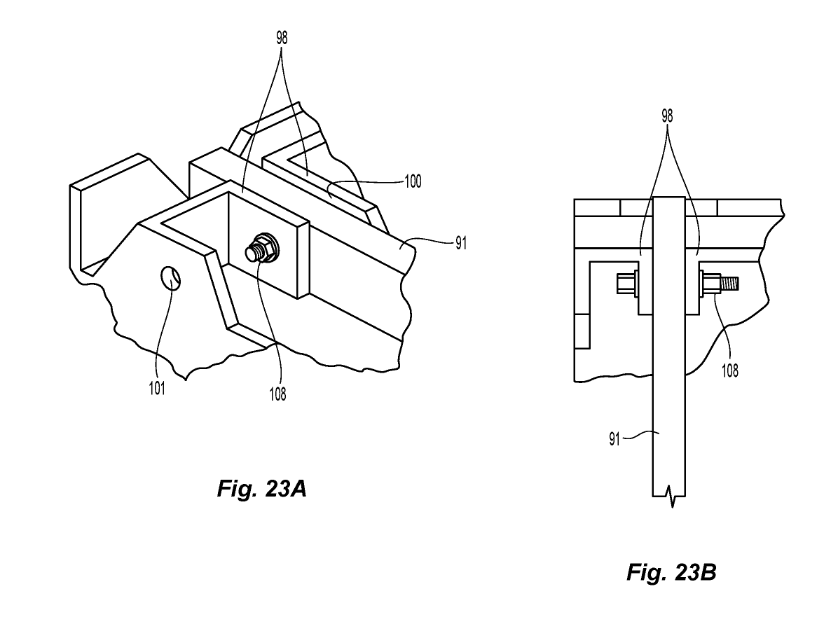

FIGS. 23A and 23B schematically depict the attachment of an elongate member 91 of framework 92 to tabs 98. In this example, member 91 is positioned in a slot 100 defined by two tabs 98. A nut and bolt assembly 108 is inserted through openings 101 in the tabs 98 and a corresponding opening in member 91 to thereby secure member 91 to tabs 98.

FIG. 22 illustrates an alternative embodiment 106 utilizing a structural framework 92 that includes a third buoyant float member 102 secured to the structural framework 92 between the first and second float members 94, 96 and disposed under elongate conveyance 22. In float assembly 106, central portion 93 which encircles conveyance 22 is positioned above a linear framework section 104 that extends from one outer float member 94 to the opposite outer float member 96. Float assembly 106 can be particularly useful if it is desired to lift conveyance 22 above the water surface.

As clearly evident from FIGS. 21 and 22, by utilizing a structural framework 92 which includes a pair of buoyant float members 94, 96 secured thereto and disposed laterally outwardly from the elongate conveyance 22 on opposing sides of the longitudinal axis 24, the resulting float assembly will resist rotation about its roll axis 26.

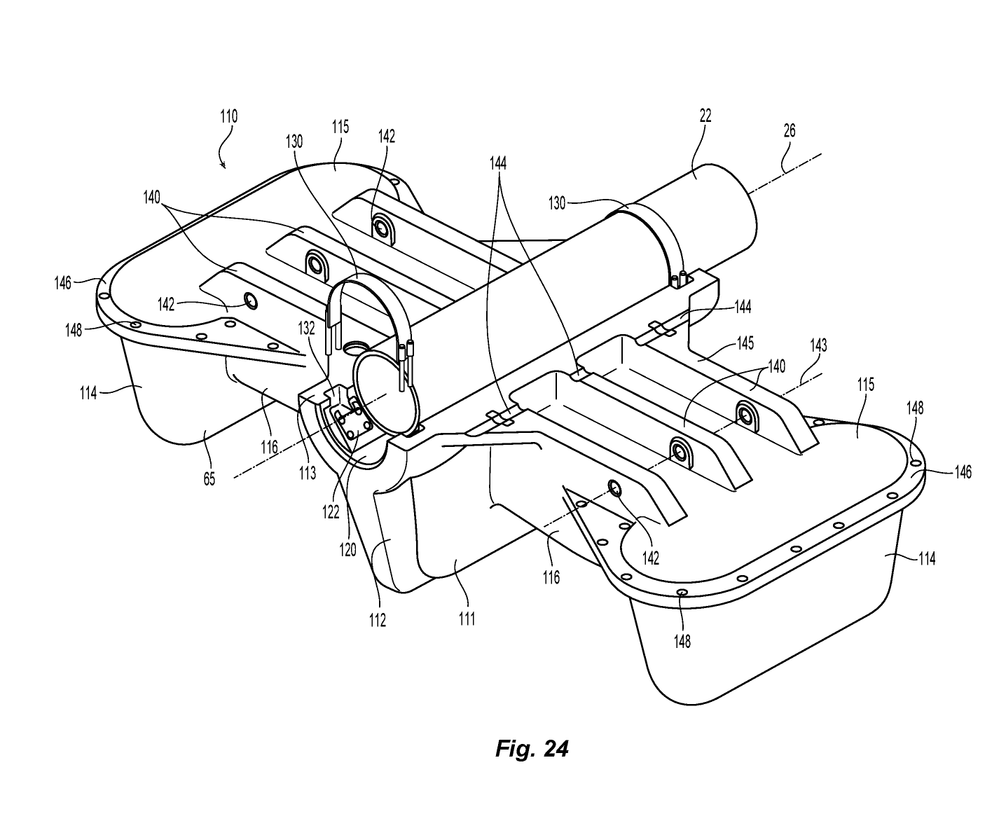

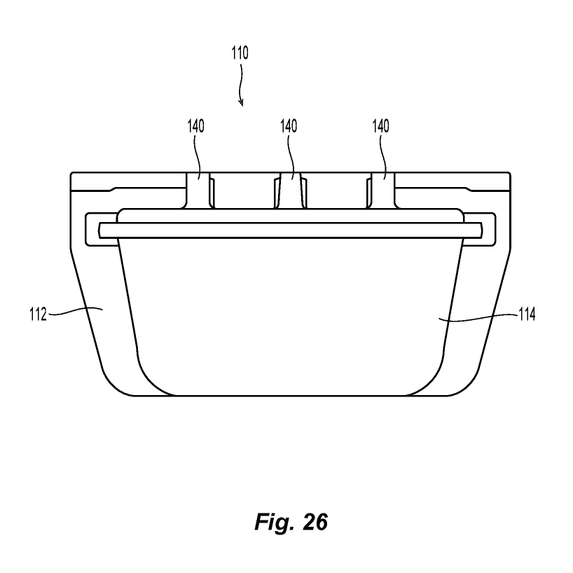

Another embodiment, float assembly 110, is illustrated in FIGS. 24-27. Float assembly 110 is securable to an elongate conveyance 22 wherein the longitudinal axis 24 of conveyance 22 is parallel with roll axis 26 of assembly 110. Similar to the embodiment depicted in FIG. 15, float assembly 110 includes a polymeric body 65 defining an enclosed interior volume 64. In the embodiment of FIGS. 24-27, polymeric body 65 defines a buoyant pipe support which is adapted to support conveyance 22 above the surface of the water.

The illustrated float assembly 110 is configured to support an elongate conveyance having a diameter within the range of 12 inches (30.48 cm) to 20 inches (50.8 cm). The illustrated float assembly 110 is also adapted to support elongate conveyance 22 above the water surface 118 of the body of water in which the float assembly is positioned. To provide the necessary buoyancy to maintain conveyance 22 above the water surface 118, float assembly 110 advantageously float assembly 110 provides an uplifting force on the elongate conveyance of at least 6,000 pounds (26,689 Newtons) when float assembly 110 is positioned in a body of water with the water surface 118 disposed 6 inches (15.24 cm) below a bottom surface 21 of the elongate conveyance 22. In other words, when waterline 118 is six inches (15.24 cm) below bottom surface 21 of conveyance 22, float assembly 110 will displace a quantity of water having a weight of at least 6,000 pounds (26,689 Newtons) plus the weight of float assembly 110. The illustrated float assembly provides an uplifting force of approximately 6,500 pounds (28,913 Newtons).

While the illustrated embodiments provide a desirable level of buoyancy, alternative embodiments may alternatively employ less or more buoyancy. In this regard, it noted that it is not only the buoyancy provided by an individual float assembly that determine if the conveyance is positioned above, at or below the waterline, but also the spacing of such floats along the longitudinal axis of the conveyance.

Body 65 of float assembly 110 includes a central float section 112 and two outer float sections 114 that are disposed on opposite lateral sides of central float section 112. The outer float sections 114 provide float assembly 110 with stability about its roll axis 26. Two arms 116 extend laterally from central float section 112 to join the outer float sections 114 with central float section 112. Each of the float sections 112, 114 and the two arms 116 are defined by a polymeric body that encloses an interior volume. The polymeric body 65 of the illustrated embodiment may be formed by a rotational molding process.

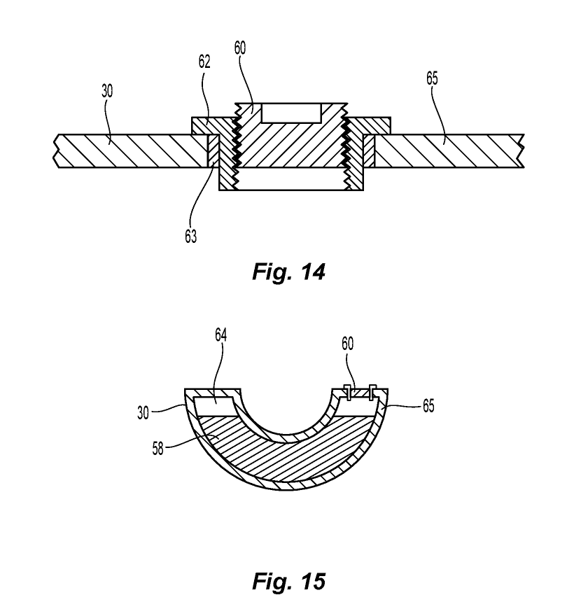

If desired, body 65 of float assembly 110 can be provided with a removable cap, similar to cap 60 depicted in FIGS. 14 and 15, to allow for the introduction and removal of ballast from body 65. The configuration of body 65, however, with outer float sections 114, will provide float assembly with stability about roll axis 26 without introducing ballast into the lower sections of float members 112, 114. Generally, the additional buoyancy will be more desirable than the additional stability that would be provided by introducing ballast into the lower portions of each of the float sections. For some applications, however, it may be desirable to use ballast with float assembly 110 to provide even greater roll axis stability.

It is also noted that the interior volume of body 65 of float assembly 110 could either be empty or filled with a foam material, e.g., a closed cell foam. The use of a foam within body 65 would provide a more rugged float assembly 110 with enhanced durability.

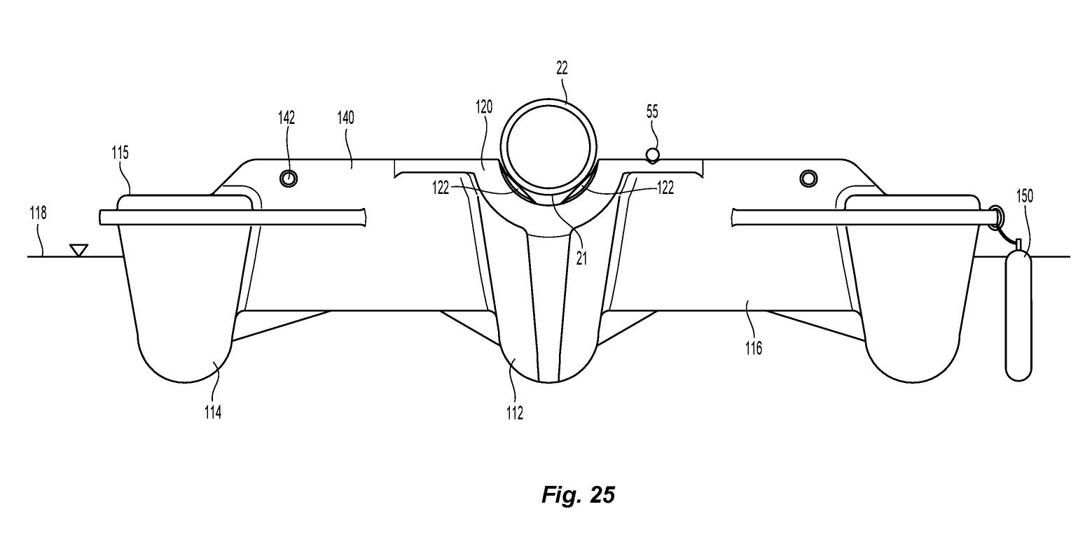

Conveyance 22 is secured to float assembly 110 above central float section 112. As can be seen in FIG. 25, the upper surface 113 of central float section 112 defines an upwardly opening trough 120 for receiving elongate conveyance 22. Trough 120 advantageously takes the form of an upwardly opening half cylinder, however, other similar upwardly opening shapes may also be employed.

A plurality of removable support pads 122 positioned on central float section 112 within trough 120 engage and support the elongate conveyance 22. Elongate conveyances 22, such as pipes, are commonly made of both polymeric materials and metal materials such as steel. By providing removable support pads 122 on float assembly 110, the pads 122 secured to float assembly 110 may be selected based upon the material used to form conveyance 22. Advantageously, at least two types of support pads 122 are available for selection with one set of pads being best suited for use with a polymeric conveyance such as pads 122 formed out of rubber or a high-density polyethylene and the other set of pads 122 being suited for use with a metal conveyance 22 such as steel pads 122. In this regard, it is noted that the use of steel pads 122 will have a long life and help protect float assembly 110 from damage when float assembly 110 is employed with a metal conveyance. The use of rubber or HDPE pads 122 will help prevent damage to polymeric conveyances 22 that might be caused by contact with metal support pads 122. The use of rubber or HDPE pads 122 with a metal conveyance 22 would likely shorten the life of the pads 122.

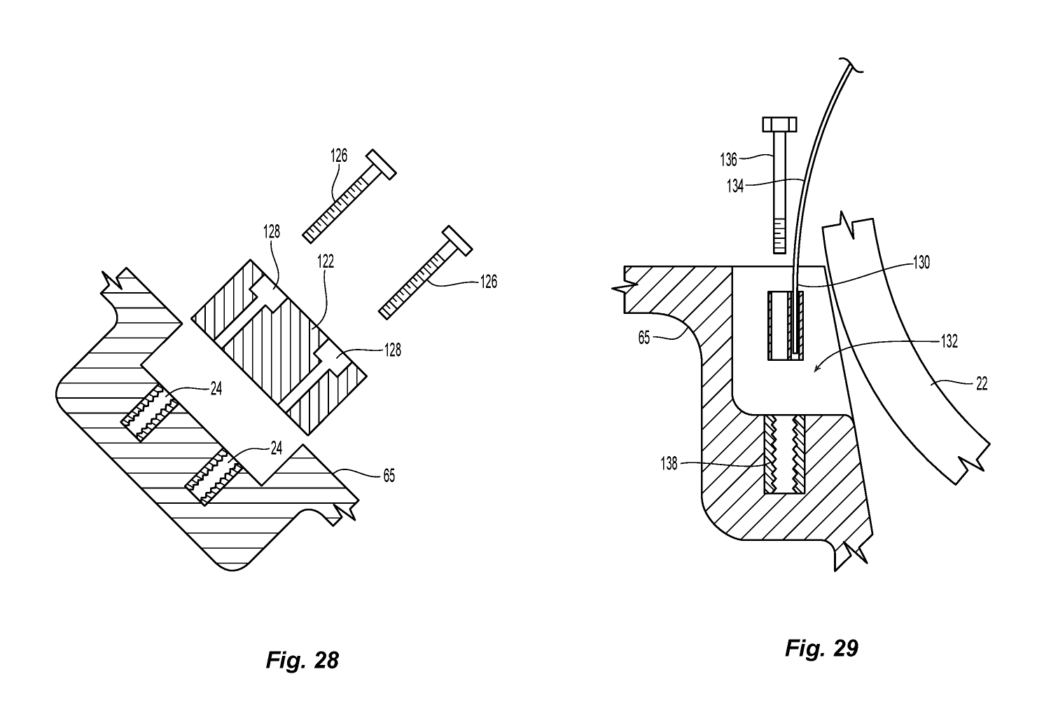

Pads 122 could be friction fit within a recess in float assembly 110. More advantageously, however, pads 122 are removably secured within a recess in float assembly 110 using threaded fasteners. FIG. 28 schematically illustrates how pads 122 are secured to float assembly 110.

Threaded inserts 124 embedded within float assembly 110 is used to engage a threaded fastener 126 that secures the pad 122. Pad 122 advantageously includes a through hole with a counterbore 128 to allow for the head of fastener 126 to be positioned below the bearing surface of pad 122 and thereby prevent contact between fastener 126 and conveyance 22.

The illustrated float assembly 110 includes four support pads 122. Although fewer support pads 122 could be employed, it will generally be desirable to use at least four pads 122. A larger number of pads 122 could alternatively be used.

After positioning conveyance 22 on float assembly 110, conveyance 22 is secured thereto with straps 130. Straps 130 are secured to float assembly 110 at attachment interfaces 132 disposed proximate support pads 122. In the illustrated embodiment, straps 130 take the form of metal bands 134 with a pair threaded fasteners 136 located at each end. Attachment interfaces 132 include threaded inserts 138 embedded within body 65 of float assembly and fasteners 136 engage threaded inserts 138 to secure straps 130 to float assembly 110 and thereby secure conveyance 22 to float assembly 110. FIG. 29 provides a schematic view of straps 130 securing a conveying conveyance 22 to float assembly 110.

In the illustrated embodiment, each of the arms 116 have a plurality of upwardly projecting and laterally extending ribs 140. Ribs 140 provide additional strength rigidity to float assembly 110. Ribs 140 on each of the arms 116 of the illustrated embodiment include apertures 142. Advantageously, apertures 142 are aligned to define an axis 143 that is parallel with longitudinal axis 24. Apertures 142 could be used to secure a rope to float assembly 110. A rigid shaft could also be inserted through a set of aligned apertures 142 to provide a means for handling or securing float assembly 110.

Ribs 140 also include a set of aligned recesses 144 on the upper surface 145 of ribs 140. Recesses 144 may receive an auxiliary line 55 which may take the form of an electrical power line, a diesel fuel line, a data communications cable, rope or other utilitarian line. If a more secure arrangement for the auxiliary line is desired, float assembly may be provided with attachment brackets 57 as depicted in FIGS. 9-12. Recesses 144 advantageously take the form of an upwardly opening half cylinder, however, other similar upwardly opening shapes may also be employed.

Float assembly 110 also includes an accessory connection interface 48 for securing an accessory such as a flag 51 or light 53 to float assembly 110. Because float assembly 110 has stability about its roll axis 26, the accessory assembly may take the form of a rigid elongate shaft 49 positioning the accessory 51, 53 at vertical distance above the float assembly 110. Without roll axis stability, an accessory positioned on the end of a rigid elongate shaft 49 would not remain upright. An example of a flag 51 positioned on an elongate shaft 49 is shown in FIG. 5 while an example of a light 53 positioned on an elongate shaft 49 is shown in FIG. 7. Detail views showing the attachment of such accessories to a float are illustrated in FIGS. 6 and 8.

The outer perimeter 146 of outer float sections 114 of the illustrated float assembly 110 include a plurality of apertures 148 that are adapted to receive a rope or similar line to allow for the attachment of a bumper 150 as can be seen in FIG. 25. Bumpers 150 are commonly attached to watercraft and positioned between the watercraft and a dock to prevent the watercraft from directly impacting the dock and causing damage to the watercraft. By attaching bumpers 150 to the outer edges of float assembly 110, the bumpers 150 can be used to cushion impacts between the float assembly 110 and watercraft, floating buoys, piers, pilings and other objects in the water.

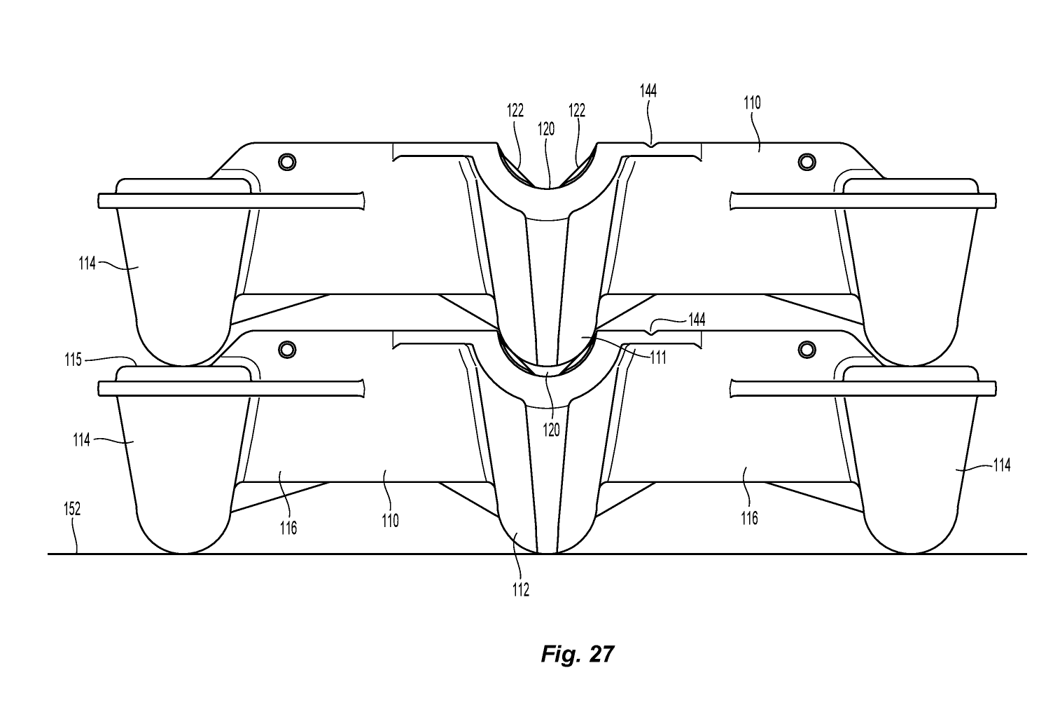

When not in use, float assemblies 110 can be vertically stacked to provide for the convenient and compact storage of the float assemblies 110 as can be seen in FIG. 27. With reference to the lower float assembly depicted in FIG. 27, when a float assembly 110 is positioned on a horizontal planar surface, the central float section 112 and each of the outer float sections 114 all contact the horizontal planar surface 152 with the two arms 116 being spaced upwardly from the horizontal planar surface. The spaces between arms 116 and ground surface 152 allow the forks of a forklift truck to be inserted between the ground surface 152 and arms 116 of the lowermost float assembly 110 to thereby allow the forklift truck to conveniently pick up and move a stack of float assemblies 110.

When stacking float assemblies 110, the upwardly opening trough 120 on the upper surface 113 of central float section 112 receives the lower portion 111 of the central float section 112 of the immediately above float assembly 110. The upper surfaces 115 of outer sections 114 are planar and at a level proximate the bottom of trough 122 such that the bottom of outer sections 114 engage and are supported on the upper surfaces 115 of the outer sections 114 of the next lower float assembly. This arrangement, with the central float section 112 being positioned in the trough 120 of the next lower float assembly 110 together with the outer sections 114 engaging the upper surface 115 of the outer sections 114 of the next lower float assembly provides the vertical stack of float assemblies 110 with significant stability.

While this invention has been described as having an exemplary design, the present invention may be further modified within the spirit and scope of this disclosure. This application is therefore intended to cover any variations, uses, or adaptations of the invention using its general principles.

What is claimed is:

1. A float assembly securable to an elongate conveyance wherein the elongate conveyance defines a longitudinal axis, the float assembly having a roll axis parallel with the longitudinal axis and comprising:
a polymeric body defining an enclosed interior volume whereby the body defines a buoyant pipe support;
the body including a central float section and first and second outer float sections disposed on opposite lateral sides of the central float section, a first arm extending laterally from the central float section to the first outer float section and a second arm extending laterally from the central float section to the second outer float section;
the elongate conveyance being securable to the float assembly above the central float section.

2. The float assembly of claim 1 wherein each of the first and second arms includes a plurality of upwardly projecting and laterally extending ribs.

3. The float assembly of claim 2 wherein each of the plurality of ribs disposed on the first arm define a plurality of upwardly opening recesses whereby a first longitudinally extending auxiliary line may be positioned in the plurality of upwardly opening recesses.

4. The float assembly of claim 1 further comprising a plurality of removable support pads positioned on the central float section to engage and support the elongate conveyance.

5. The float assembly of claim 4 wherein central float section defines an upwardly opening trough on its upper surface for receiving the elongate conveyance, the plurality of removable support pads being disposed within the trough and wherein a plurality of attachment interfaces are disposed on the central float section whereby securement straps engaging the elongate conveyance can be secured to the float assembly at the attachment interfaces.

6. The float assembly of claim 1 wherein an outer perimeter of each of the first and second outer float sections defines a plurality of apertures, each of the plurality of apertures being adapted to secure a line attaching a bumper to the float assembly.

7. The float assembly of claim 1 wherein, when the float assembly is positioned on a horizontal planar surface, the central float section and each of the first and second outer float sections all contact the horizontal planar surface with the first and second arms being spaced upwardly from the horizontal planar surface.

8. The float assembly of claim 7 wherein central float section defines an upwardly opening trough on its upper surface for receiving the elongate conveyance and wherein a plurality of the float assemblies are vertically stackable when positioned on a horizontal planar surface with a lower portion of the central float section of a first float assembly being positioned in the upwardly opening trough of a second float assembly.

9. The float assembly of claim 1 further comprising an accessory connection interface for securing a rigid elongate shaft to the float assembly, the rigid elongate shaft positioning an accessory at a vertical distance above the float assembly.

10. The float assembly of claim 1 wherein the float assembly is adapted to support the elongate conveyance above a water surface.

11. The float assembly of claim 10 wherein the float assembly is adapted to support an elongate conveyance having a diameter within the range of 12 inches (30.48 cm) to 20 inches (50.8 cm) and wherein the float assembly provides an uplifting force on the elongate conveyance of at least 6,000 pounds (26,689 Newtons) when the float assembly is positioned in a body of water with the water surface disposed 6 inches (15.24 cm) below a bottom surface of the elongate conveyance.

12. A float assembly securable to an elongate conveyance wherein the elongate conveyance defines a longitudinal axis, the float assembly having a roll axis parallel with the longitudinal axis and comprising:
a body defining an enclosed interior volume whereby the body defines a first buoyant float member;
wherein the float assembly has a configuration wherein buoyancy and gravitational forces acting on the float assembly resist rotation of the float assembly about the roll axis when the float assembly is secured to the elongate conveyance and disposed in a body of water; and
wherein the float assembly allows rotation of the elongate conveyance relative to the float assembly when the float assembly is secured to the elongate conveyance.

13. The float assembly of claim 12 wherein the float assembly further comprises a stop surface engageable with a collar or flange disposed on the elongate conveyance to thereby limit longitudinal movement of the float assembly on the elongate conveyance.

14. The float assembly of claim 13 wherein the stop surface is defined by a recess in the first float member wherein the recess is spaced longitudinally inwardly from opposite longitudinal ends of the first float member.

15. The float assembly of claim 14 further comprising a second float member securable to the first buoyant float member to thereby encircle the elongate conveyance and wherein the second float member defines a second recess, the second recess and the recess disposed on the first float member defining a toroidal recess for receiving the collar or flange disposed on the elongate conveyance.

16. The float assembly of claim 12 further comprising ballast coupled with the float assembly to thereby maintain the float assembly in a desired orientation when secured to the elongate member and disposed in a body of water.

17. The float assembly of claim 16 wherein the ballast is positioned below and external to the first float member when the float member is secured to the elongate conveyance and disposed in a body of water.

18. The float assembly of claim 12 wherein the first buoyant float member comprises first and second buoyant float members, the first and second buoyant float members being spaced laterally outwardly from the roll axis and disposed on opposite sides of the roll axis when the float assembly is secured to the elongate conveyance and disposed in a body of water.

19. The float assembly of claim 18 wherein the float assembly further comprises a third buoyant float member secured to the elongate conveyance and wherein the first and second buoyant float members are integrally formed with the third buoyant float member.

20. The float assembly of claim 19 further comprising a fourth float member, the fourth float member being securable to the third buoyant float member whereby the third and fourth float members encircle the elongate conveyance.

21. The float assembly of claim 18 further comprising a structural framework formed out of a plurality of elongate rigid members, the first and second buoyant float members being secured to the structural framework, the structural framework being securable to the elongate conveyance whereby the first and second buoyant float members are disposed laterally outwardly from the elongate conveyance on opposing sides of the longitudinal axis and thereby resist rotation of the float assembly about the roll axis.

22. The float assembly of claim 21 further comprising a third buoyant float member secured to the structural framework between the first and second float members and disposed under elongate conveyance.

23. The float assembly of claim 21 wherein the first and second buoyant float members include attachment tabs extending outwardly therefrom, the structural framework being secured to at least one of the attachment tabs on each of the first and second buoyant float members.

24. The float assembly of claim 23 wherein each of the first and second buoyant float members includes a plurality of attachment tabs, the tabs defining at least one slot on each of the first and second buoyant float members, at least one of the plurality of elongate rigid members forming the structural framework being disposed in the at least one slot on each of the first and second buoyant float members.

25. The float assembly of claim 12 further comprising a keel member coupled with the float assembly and projecting away from the elongate conveyance and below a water surface when the float assembly is secured to the elongate conveyance and positioned in a body of water.

26. A float assembly securable to an elongate conveyance wherein the elongate conveyance defines a longitudinal axis, the float assembly having a roll axis parallel with the longitudinal axis and comprising:
a body defining an enclosed interior volume whereby the body defines a first buoyant float member;
wherein the float assembly has a configuration wherein buoyancy and gravitational forces acting on the float assembly resist rotation of the float assembly about the roll axis when the float assembly is secured to the elongate conveyance and disposed in a body of water; and
a second float member defining a second enclosed interior volume, the second float member being securable to the first buoyant float member whereby the first and second float members encircle the elongate conveyance when secured thereto.

27. The float assembly of claim 26 wherein the float assembly allows relative rotation of the first and second float members and the elongate conveyance when the first and second float members are secured to the elongate conveyance.

28. The float assembly of claim 26 wherein the second float member includes a removable cap for controlling access to an interior volume of the second float member and thereby allowing ballast to be added and removed from the interior volume.

29. The float assembly of claim 26 wherein the float assembly further comprises ballast positioned below and external to the first and second float members when the first and second float members are secured to the elongate conveyance and disposed in a body of water.
